(19) United States
(12) Patent Application Publication
(10) Pub. No.: US 2016/0088093 A1
(43) Pub. Date: Mar. 24, 2016

(54) DYNAMIC DATA MANAGEMENT

(71) Applicant: V5 Systems, Inc., Fremont, CA (US)

(72) Inventors: Steven Yung, Newark, CA (US); Alexander Motyashov, Belmont, CA (US)

(21) Appl. No.: 14/863,813

(22) Filed: Sep. 24, 2015

Related U.S. Application Data
(60) Provisional application No. 62/054,858, filed on Sep. 24, 2014.

(51) Int. Cl. H04L 29/08; H04L 29/06

(52) U.S. Cl. CPC H04L 67/141; H04L 67/42

(57) ABSTRACT

Client devices have a variety of options for receiving data via data services. Among those options may include various different interfaces and connection types. One example operation of a client device may include at least one of establishing a first data session between a client device and a first data service provider, monitoring the data session for a loss of communication data for a predetermined period of time, identifying the predetermined period of time has expired without data session activity, terminating the first data session, retrieving data session preferences from memory, and establishing a second data session between the client device and a second data service provider based on the data session preferences.

### CROSS-REFERENCE TO RELATED APPLICATION

This application claims the benefit of U.S. Provisional Patent Application No. 62/054,858, filed on Sep. 24, 2014 and entitled REAL-TIME OBJECT TRACKING PROTOCOL. The subject matter of this application is hereby incorporated by reference herein in its entirety.

### TECHNICAL FIELD OF THE APPLICATION

This application relates to data management for providing data services and in particular to a dynamic data service seeking application and related network configuration.

### BACKGROUND OF THE APPLICATION

Conventional data network environments provide access to data services, bandwidth services, Internet access, etc., via a data service provider and a corresponding network infrastructure to distribute such services accordingly. Well known protocols, such as Transmission Control Protocol (TCP) provide a foundation for communication among network devices. Those skilled in the art will appreciate that various network protocols can be used to transmit and receive data on such networks. However, TCP is a common communication protocol which operates via a three-way handshake to ensure the communication status of the communication devices. For example, a device may transmit a request and receive an acknowledgment before transmitting a response acknowledgment to verify a communication channel.

In order to establish a communication channel between network devices, the TCP protocol is fundamental to achieving a successful connection. However, the mere fact that a channel is setup during an initial communication procedure does not ensure that the communication will be maintained by correcting network failures, loss of data connections, bandwidth degradation, etc. These factors, as well as others, all make the process of sending and receiving data cumbersome, inefficient or impossible. For example, a communication failure may be caused by a loss in available bandwidth. In this event, a computing device may experience a tremendous delay which could be several seconds, minutes or longer prior to any action being taken by an application environment to at least provide a confirmation that a failure has occurred.

Also, the likelihood of a data service failure resulting in an automated data connection repair operation is unlikely as the usual course of action is to notify technical assistance via a notification message or other communication effort. These types of failures are seldom self-repairing or efficient at self-repairing efforts. A network failure is generally a situation that will require an existing data service provider to repair itself or the failure may continue indefinitely.

Summary of the Application

One example embodiment may provide a method that includes at least one of establishing a first data session between a client device and a first data service provider, monitoring the data session for a loss of communication data for a predetermined period of time, identifying the predetermined period of time has expired without data session activity, terminating the first data session, retrieving data session preferences from memory, and establishing a second data session between the client device and a second data service provider based on the data session preferences.

Another example embodiment may provide a method that includes at least one of establishing a first data session between a client device and a first data service provider via a first interface of the client device, transmitting an echo request to a known reference point server, initiating a timer to begin responsive to the echo request being transmitted, and determining whether to restart a connection of the first data session and change to a second data service provider.

Still another example embodiment may provide a method that includes at least one of establishing a data session between a client device and a first data service provider via a first interface of the client device, receiving a portion of a message, determining whether the message is complete, initiating a timer, and identifying a predetermined period of time has expired without a response being received to the echo message.

Still yet a further example embodiment may provide a method that includes at least one of initiating a static route from a first interface of a client device to a destination device, transmitting an echo request to the destination device over a first data connection, determining whether to mark the interface as being up or down based on a result of the echo request, and assigning the interface to a gateway device.

Yet a further example embodiment may provide an apparatus comprising at least one of a transmitter configured to establish a first data session between a client device and a first data service provider, and a processor configured to provide at least one of monitor the data session for a loss of communication data for a predetermined period of time, identify the predetermined period of time has expired without data session activity, terminate the first data session, retrieve data session preferences from memory, and establish a second data session between the client device and a second data service provider based on the data session preferences.

Still another example embodiment may provide a non-transitory computer readable storage medium configured to store instructions that when executed cause a processor to perform at least one of establishing a first data session between a client device and a first data service provider, monitoring the data session for a loss of communication data for a predetermined period of time, identifying the predetermined period of time has expired without data session activity, terminating the first data session, retrieving data session preferences from memory; and establishing a second data session between the client device and a second data service provider based on the data session preferences.

### BRIEF DESCRIPTION OF THE DRAWINGS

FIG. 1 illustrates a large-scale data service network configuration diagram according to an example embodiment of the present application.

FIG. 2 illustrates a system communication diagram of a data session and echo test procedure according to an example embodiment of the present application.

FIG. 3 illustrates a logic flow diagram of a client-side network monitoring procedure according to an example embodiment of the present application.

FIG. 4 illustrates a logic flow diagram of a server-side network monitoring procedure according to an example embodiment of the present application.

FIG. 5 illustrates a logic flow diagram of a network monitoring procedure according to an example embodiment of the present application.

FIG. 6 illustrates a data source network change-over configuration according to an example embodiment of the present application.

FIG. 7 illustrates a system configuration configured to perform one or more of the example embodiments of the present application.

FIG. 8 illustrates an example network entity device configured to store instructions, software, and corresponding hardware for executing the same, according to example embodiments of the present application.

FIG. 9 illustrates a surveillance device operating on a corresponding data network for a first and second connection period according to example embodiments.

FIG. 10 illustrates a surveillance device operating on a corresponding data network for a first and second IP address according to example embodiments.

FIG. 11 illustrates a surveillance device operating on a corresponding data network for a first and second connection period with an alternative network configuration according to example embodiments.

FIG. 12 illustrates a flow diagram of a first and second network configuration and testing packet configuration according to example embodiments.

FIG. 13A illustrates a camera and sensor configuration according to example embodiments.

FIG. 13B illustrates another camera and sensor configuration according to example embodiments.

FIG. 14 illustrates yet another camera and sensor configuration according to example embodiments.

FIG. 15A illustrates a camera and shipment package measurement network configuration according to example embodiments.

FIG. 15B illustrates a camera and shipment package measurement network configuration according to example embodiments.

FIG. 15C illustrates a camera and shipment package measurement network configuration according to example embodiments.

FIG. 16 illustrates a flow diagram of a sensor measurement and packet measuring configuration according to example embodiments.

### DETAILED DESCRIPTION OF THE APPLICATION

It will be readily understood that the components of the present application, as generally described and illustrated in the figures herein, may be arranged and designed in a wide variety of different configurations. Thus, the following detailed description of the embodiments of a method, apparatus, and system, as represented in the attached figures, is not intended to limit the scope of the application as claimed, but is merely representative of selected embodiments of the application.

The features, structures, or characteristics of the application described throughout this specification may be combined in any suitable manner in one or more embodiments. For example, the usage of the phrases “example embodiments”, “some embodiments”, or other similar language, throughout this specification refers to the fact that a particular feature, structure, or characteristic described in connection with the embodiment may be included in at least one embodiment of the present application. Thus, appearances of the phrases “example embodiments”, “in some embodiments”, “in other embodiments”, or other similar language, throughout this specification do not necessarily all refer to the same group of embodiments, and the described features, structures, or characteristics may be combined in any suitable manner in one or more embodiments.

In addition, while the term “message” has been used in the description of embodiments of the present application, the application may be applied to many types of network data, such as, packet, frame, datagram, etc. For purposes of this application, the term “message” also includes packet, frame, datagram, and any equivalents thereof. Furthermore, while certain types of messages and signaling are depicted in exemplary embodiments of the application, the application is not limited to a certain type of message, and the application is not limited to a certain type of signaling.

According to example embodiments, the TCP communication protocol generally relies on previous round-trip information when attempting to maintain an active connection. In operation, TCP sends retransmissions in an attempt to receive an acknowledgement or confirmation response. The time lapse before a TCP-based protocol network can identify a network connection has failed is generally 10-12 minutes. The practicality of such a configuration is not suitable for many network environments that require immediate access to an alternative source of data communications.

The example embodiments provide an add-on service that can be utilized with existing network protocol infrastructures of the application, transport, Internet and link layers including but not limited to TCP, UDP, BGP, DHCP, DNS, FTP, HTTP, IMAP, LDAP, MGCP, NNTP, NTP, POP, ONC/RPC, RTP, RTSP, RIP, SIP, SMTP, SNMP, SSH, Telnet, TLS/SSL, XMPP, DCCP, SCTP, RSVP, IP, IPv4, IPv6, ICMP, ICMPv6, ECN, IGMP, IPsec, ARP, NDP, OSPF, L2TP, PPP, MAC, Ethernet, DSL, ISDN, FDDI, etc.

In operation, a lost connection as determined by a failure to receive a confirmation acknowledgement or other notification message from another device in an established session may be detected promptly without unnecessary delay. This failed condition may be identified within a few seconds and an attempt to recover by reconnecting, restarting the interface, rebooting the device, etc. may be performed in succession beginning just seconds after the failed condition. The time period used to identify a failed condition may be one of a plurality of threshold time limits (i.e., 5 seconds, 8 seconds, 10 seconds, 12 seconds, 15 seconds, 30 seconds, or more, etc.).

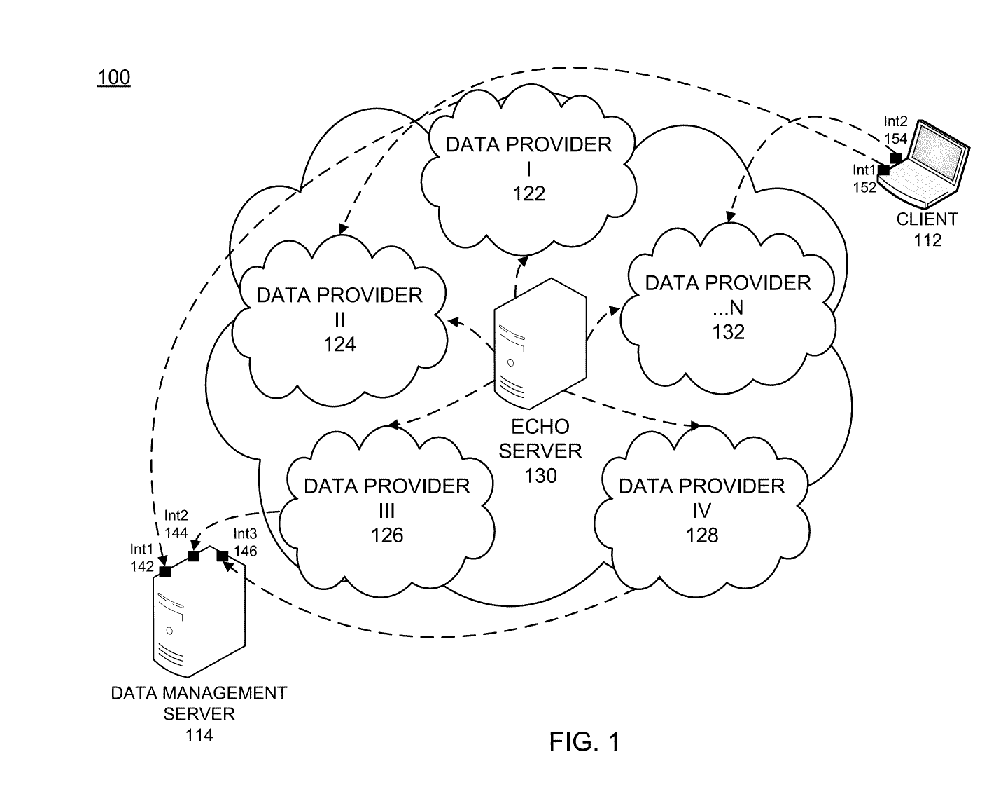

FIG. 1 illustrates a communication network configuration according to example embodiments. Referring to FIG. 1, the network 100 includes a series of data providers 122 I . . . 132 N, a client device 112 with two data interfaces 152 and 154, a data management server 114 with three data interfaces 142, 144 and 146, and an echo server 130 which operates as a well-known server that can be used to identify data service availability. The data service providers 122, 124, 126, 128, 132, etc., may be Internet service providers, in the form of cable networking, fiber communications, WIFI, 4G cellular communications, satellite communications. The data service providers may be potential data service candidates based on predetermined selection criteria (e.g., convenience preference, cost preference, availability preference, reliability preference, etc.) In operation, an echo message may be forwarded from any of the devices actively participating in an on-going communication session with any of the data service providers.

The echo server may be any well-known server, such as a reliable web site server(s), that can be used as a reference point for ongoing monitoring and network cost analysis. For example, during an active session between the client device 112 and data provider II 124, a monitoring service application may transmit an echo message to the well-known echo server 130, or any other point of reference server. The echo message may be used as a reference to identify latency, bandwidth degradation with one data provider and a more optimal communication scenario with another data provider.

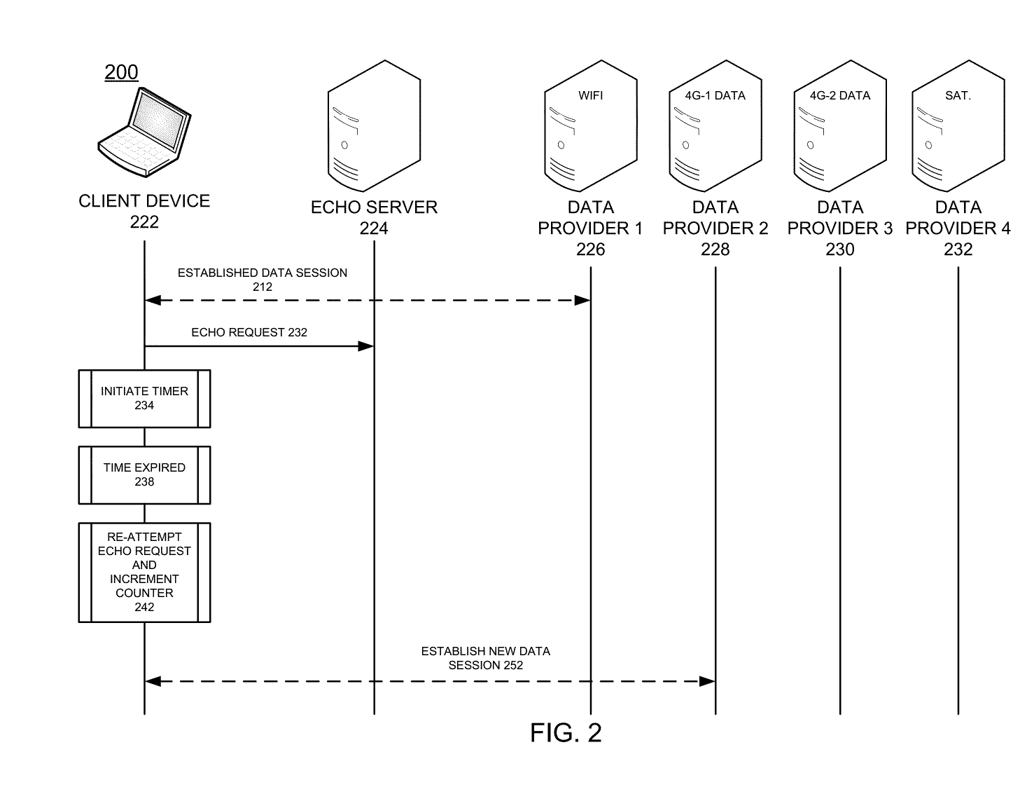

FIG. 2 illustrates a system communication diagram of a data session and echo test procedure according to an example embodiment of the present application. Referring to FIG. 2, the system communication flow 200 includes a client device 222, which represents a recipient of data services. An initial communication session 212 may be established between the client device 222 and a first data provider 226. The client device 222 may have a plurality of data provider service affiliates which are setup to communicate with the device and which are also in communication with the device contemporaneously. The various data providers are in communication with the client device via other communication ports of the device or via a common portion of the client device in an alternative configuration. The data providers 226, 228, 230 and 232 may be on stand-by awaiting a command to elevate the data service from an active status to an in-active status depending on the data connection change-over that is warranted by the data connection manager application.

Referring again to FIG. 2, during the established data session, the client device 222 may have an active plug-in, background application, etc., that is operating on the client device and which is constantly monitoring the data traffic and status of the data providers at any given moment. One approach to monitoring the connection and reliability of the data provider is via an echo message from the client device 222 to an echo server 224 via the various data ports of the client device 222. In this configuration, each of the data providers 226, 228, 230 and 232 may be tested and updated as active data providers in the event that the first data provider fails. The echo response to the well-known echo server 224 provides a basis for bandwidth availability, latency, current status of the data provider, etc. A well-known server or echo server 224 can be any reference point in the Internet that is reliable as a basis for test measurements. During the echo cycle, the client device 222 may initiate a timer 234 for a predetermined period of time (e.g., 5 seconds, 10 seconds, 15 seconds, or more, etc.). Once that time period expires 238, the application may be setup to re-attempt the echo and timer cycle a certain number of times (e.g., 2, 3, 4, 5, etc.). A counter may be incremented to keep track of the number of times an echo signal is sent and a response is received. In the event that the first data provider fails and/or an echo signal indicates a more optimal connection based on connection preferences, then the new data session 252 may be established with the next most qualified data provider service, such as data provider 228 as illustrated in FIG. 2.

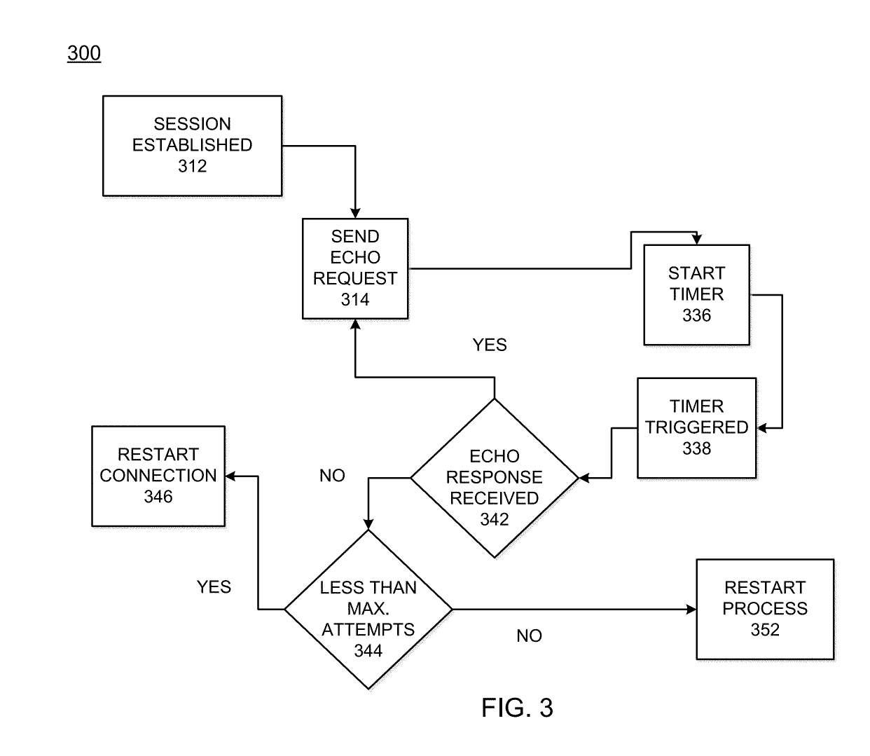

FIG. 3 illustrates a logic flow diagram of a client-side network monitoring procedure according to an example embodiment of the present application. In this example, the client-side application may be performing a monitoring operation to ensure the reliability of the data service provider and other candidate data service providers. The session may be established 312 between a first client device and a first data provider. The session may include an ongoing network connection to the Internet or other data network. During the ongoing connection, the client device may be utilizing the first data provider via a first port of the client device. As the session continues, an echo request message 314 may be transmitted from the client device via the first port to a first data provider server and/or the well-known server (i.e., echo server). A timer may be initiated to begin counting 336 at the moment the request is sent. After a predetermined period of time, the timer will be deemed triggered 338 and a determination is made as to whether an echo response is received 342. If so, the process re-cycles and another echo request may be sent 314 to ensure continued network availability. If no echo response is received then the counter will be checked to determine whether the threshold number of test cycles have been performed to ensure the network is actually down. If the number of attempts 344 is less than the threshold number then a connection restart may be performed 346 which simply re-attempts to establish a connection without exiting an ongoing process and without terminating a connection and restarting the device. However, in the event that the number of attempts has been performed, then the process restarts 352 and a new connection may be sought by the client device while the previous data provider connection is terminated for failing to provide adequate data service.

The number of reconnect attempts ensures that the connection tests are accurate since the network may be congested and some packets may be dropped, and thus several attempts will provide a more reliable result and reduce false positives of a potentially failed network. The process restart may include soliciting another data connection via a better path, such as via different hops so new connections are not data throttled as much as some others.

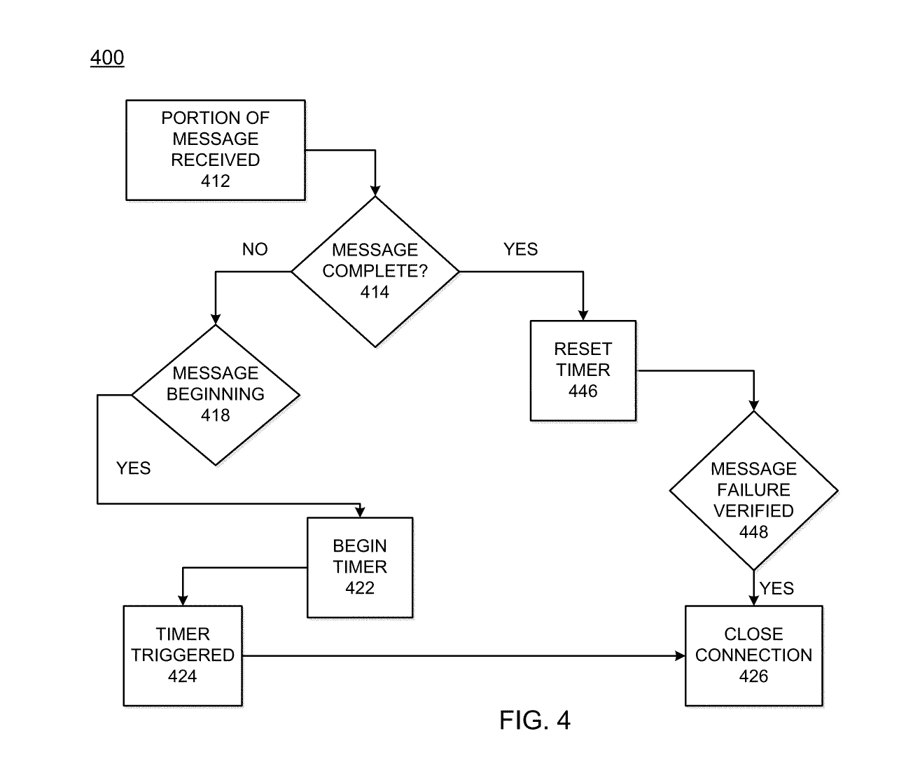

FIG. 4 illustrates a logic flow diagram of a server-side network monitoring procedure according to an example embodiment of the present application. Referring to FIG. 4, the server-side monitoring is more of a passive form of monitoring which is performed via message verification to identify message failures and transit errors as opposed to an ongoing time verification that is always monitoring the time required for a response to be received. For instance, an active application may be identifying messages received via the client device and whether a portion of a message is received 412. In this event, a determination will be made as to whether the message is complete 414. If not, the application may determine if the portion of the message is the message beginning 418, and if so, then the timer will be initiated to begin counting 422 until the timer is triggered 424 at the predetermined amount of time. At this time, the connection may be closed 426 for a lack of communication. In the event that the message is complete, a timer may be reset 446 and a message verification process is deemed to have failed 448 and the connection may be closed 426. When the connection is closed, the next data provider may be solicited via another client device portion for a new data session. The next data provider may be solicited via a request or setup message that is sent during the testing of the first data connection or after the connection is closed.

In operation, a message may be delivered by several packets. For example, messages may be several megabytes. If a traditional TCP connection is used without the present application and the connection fails, it could take many minutes for all the retransmissions and timeouts to indicate a failure has occurred. If the timer is triggered, this indicates that the message was not delivered within the expected time. As a result, if the message was not delivered on time, the connection is dropped and the resources are released.

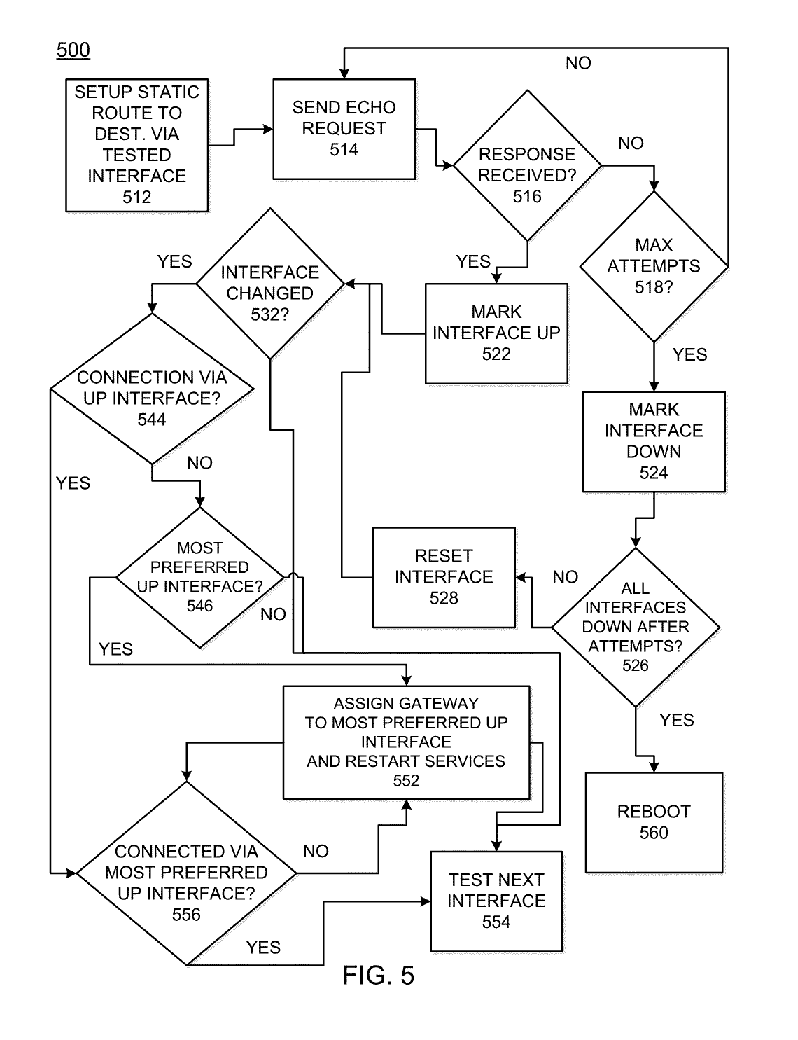

FIG. 5 illustrates a logic flow diagram of a network monitoring procedure according to an example embodiment of the present application. Referring to FIG. 5, the configuration 500 includes a network monitoring configuration that attempts to identify all the interfaces/ports available for a client device. Different interfaces are connected to different providers, which provide various data service backup options to a particular device with multiple data providers available. If the main (i.e., most preferred) provider is down or the whole network is not working then other options must be explored sooner rather than after a long timeout status has passed. In one example, on the deployment scenario there may be several interfaces available to a user device. For example, interface 0—local WIFI provided by an Internet service provider via cable Internet, telephone line, fiber optic cables, etc., interface 1—cellular carrier 4G service from company XYZ, interface 2—cellular carrier 4G service from company ABC, interface 3—satellite data service from a satellite service provider. A user profile affiliated with a user device may include various data service provider selection criteria. The criteria may be based on reliability, bandwidth, cost, or a combination thereof, the parameters may be various parameters which are ordered in a priority format so they may be weighted accordingly. When the connection testing is performed the results may be re-ordered in an order of data connection options based on the preferences. The most preferred interface is generally a faster and less cost having interface for traffic sending/receiving.

Referring again to FIG. 5, the diagram 500 includes a test procedure conducted on the network that is available for use by the client device. For instance, the available connections, the well-known server, the ports of the client device, etc., may be tested and monitored for optimal communication options. During an initial setup procedure, a static route 512 may be identified to a destination via a tested interface of the client device or a known gateway, etc. At this time, an echo request 514 may be transmitted to identify the status of the data provider for that particular interface. A response may be received 516 and the interface may be marked as “up” 522, which indicates the interface is available as a viable data communication interface ready for use. Alternatively, the interface may be marked down due to a lack of an echo request response message within a pre-allocated amount of time indicating the data connection is not optimal or is not available. The number of attempts may be counted and the attempts may be continued until a threshold number of echo request/response attempts have been reached (i.e., 2-5 attempts). In this case, the failed attempts may result in the interface being marked down 524. As a result, the other interfaces are attempted via the same procedure the same number of attempts 526. If all interfaces fail to provide any confirmation of data services then the system may be rebooted 560. In the event that at least one interface exists then the interface may be reset 528 for immediate availability.

Next, a determination may be made as to whether an interface needs to be changed 532 and if not then a next interface may be checked and tested 554. If so, an ‘up’ interface may be identified and selected for a connection status 544. A determination as to whether the interface is an up interface may be performed 546 and if so then that interface will be assigned to the gateway 552 and the service may be restarted accordingly with the new interface assigned. Similarly, if the up interface is identified as a most preferred up interface than it will be assigned accordingly 556.

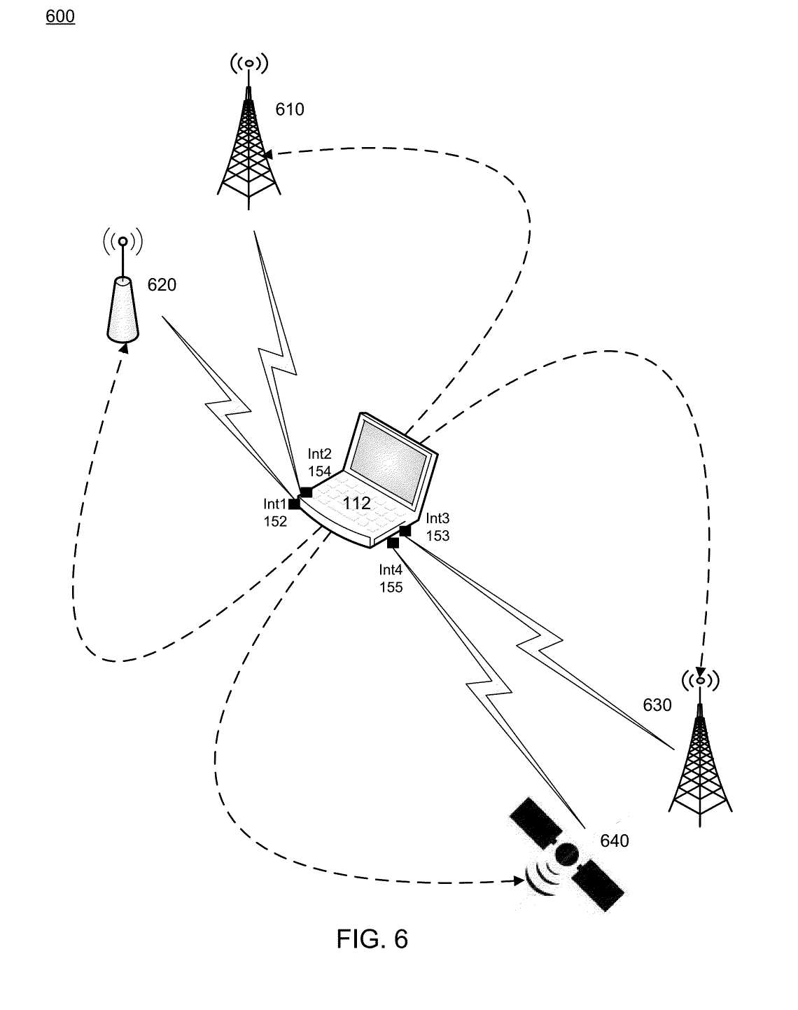

FIG. 6 illustrates a data source network change-over configuration according to an example embodiment of the present application. Referring to FIG. 6, the client device 112 may have a plurality of operable ports/interfaces 112. The interfaces 152-155 are for four different data service providers. In actuality, the number of data service providers configured to provide data services may be more or fewer in number. In this example, the first interface 152 is in communication with a WIFI hot spot 620. The second and third interfaces are communicating with 4G communication towers 610 and 630 and the fourth interface 155 is communicating with a satellite data service 640. Any of the data service providers may be offer data services to the client device in the event that the others cannot offer data services and based on the selection operations and preferred criteria of the client device preferences.

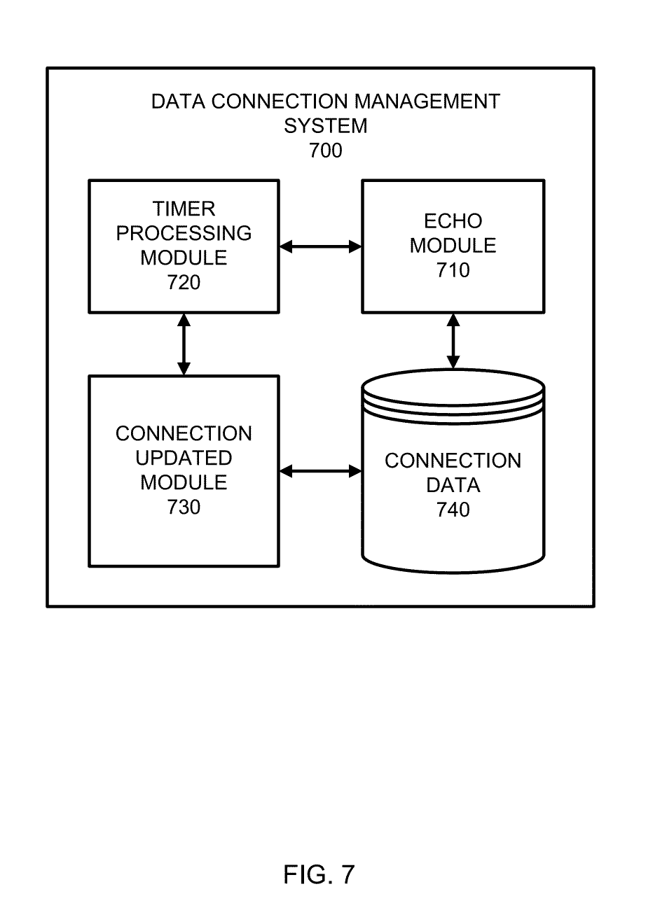

FIG. 7 illustrates a system configuration configured to perform one or more of the example embodiments of the present application. Referring to FIG. 7, the data connection management system 700 may include various modules as a stand-alone server or a set of computers working together to perform the related tasks. The system 700 may include an echo module 710 that initiates and receives echo signals and updates the data communication status via the timer processing module 720 which keeps track of time since the echo requests are sent. Any feedback or lack thereof is identified and logged by the connection update module 730 which stores the connection data and status information in the memory 740.

One example embodiment may include the system 700 establishing a first data session between a client device and a first data service provider, monitoring the data session for a loss of communication data for a predetermined period of time, identifying the predetermined period of time has expired without data session activity as determined by the counter and terminating the first data session as a result. Also, data session preferences may be retrieved from memory 740 and establishing a second data session between the client device and a second data service provider based on the data session preferences.

The first data session may be established via a first port of the client device and the second data session may be established via a second port of the client device. The predetermined period of time may expire without data session activity by identifying that no acknowledgment message was received at the client device within the predetermined period of time. A first data session preference for connection reliability may be identified from the stored preferences of the client device and a second data session preference for connection cost may also be applied. The second data service provider may be selected based on the first data session preference and the second data session preference. The first data service provider may include a local WIFI connection and/or a wired connection and the second data service provider may include a 4G cellular data provider and/or a satellite data provider.

At least one data packet may be sent to the first data service provider to identify network activity, a timer may then be initiated responsive to transmitting the at least one data packet. Once the timer has expired, and it is determined that no acknowledgment was received within the predetermined period of time, a request to initiate a data session with the second data service provider may be transmitted to setup a new session. Also, a message may be transmitted to an echo server to identify a candidate data service provider and an echo response message may be received. As a result, the candidate data service provider is selected as the second data service provider based on the echo response message when the first data service provider fails to provide data services to the client device.

According to another example embodiment, a first data session is established between a client device and a first data service provider via a first interface of the client device, next an echo request is transmitted to a known reference point server, and a timer is initiated to begin responsive to the echo request being transmitted, and a determination is made as to whether to restart a connection of the first data session and change to a second data service provider. Next, a predetermined period of time is identified as having been expired without a response being received to the echo message. The testing may be checked to determine whether a threshold number of echo message attempts have been performed. When the threshold number of echo message attempts have been performed, the first data session may be terminated since the connection is not operating. Then, an attempt to establish a second data session via a second data service provider different from the first data service provider can be performed. A data session request message is then transmitted via a second interface of the client device and a confirmation from the second data service provider is received. As a result, a connection with the second data service provider via the second interface is established. The first data service provider may include a local WIFI connection and/or a wired connection and the second data service provider may include a 4G cellular data provider and a satellite data provider or vice versa. The predetermined period of time may be less than an amount of time required by a protocol used during the first data session to determine whether a network communication failure has occurred.

According to another example embodiment, a data session may be established between a client device and a first data service provider via a first interface of the client device. Next, a portion of a message may be identified as having been received. The message may be examined to determine whether the message is complete and a timer is then initiated. Next, a predetermined period of time is identified as having been expired without a response being received to the echo message. The message is determined as not complete when a beginning of the message was received and the message is not complete. A timer is initiated for a predetermined period of time and when the timer has expired the session is closed. In the event that the message is identified as being complete then the timer is reset and a message verification is identified as having failed and that session is closed. Next, an attempt to establish a second data session via a second data service provider different from the first data service provider is performed by transmitting a data session request message via a second interface of the client device and receiving a confirmation from the second data service provider. As a result, a connection with the second data service provider is established via the second interface. The predetermined period of time is less than an amount of time required by a protocol used during the first data session to determine whether a network communication failure has occurred. For instance, the protocol may timeout when no response is received after several minutes, however, the timer is set to a predetermined period of second that is shorter than the protocol timeout event.

According to another example embodiment, a static route is setup from a first interface of a client device to a destination device and an echo request is transmitted to the destination device over a first data connection. A determination is then made whether to mark the interface as being “up” or “down” based on a result of the echo request, and the interface is assigned to a gateway device. The static route is setup via a tested interface and additional interfaces of the client device are tested to determine whether the additional interfaces are up or down as well. During the interface audit procedure, the network connections may be tested for data network support by transmitting a test packet and receiving a response prior to identifying the interface as up or down. A most preferred interface is also selected based on the interfaces that are up and preferences associated with the client device regarding reliability, cost, availability and type of connection. The most preferred interface for a data session is setup as well based on the preferences. In the event that all interfaces are designated as being down, the client device is rebooted. The preferences associated with the client device include at least one of a convenience preference, a cost preference, an availability preference, and a reliability preference. A state of an “up” interface is modified responsive to identifying at least one “up” interface of the client device. During this process, a most preferred interface that is not being utilized by the client device and which is up may be designated as the active interface and an active session may be closed and a new session may be initiated via the most preferred interface.

During the network monitoring configuration the rebooting of the client device is generally performed only after all the interface testing yields a negative result. For example, if a client device interface is down, the initial action is to reset that interface and monitor again to identify whether the problem is resolved. A reboot is performed after all the interfaces on the client device have failed after one or more sequential resets and monitor operations.

The application that is installed on the client device, the network server, etc., which monitors the connectivity is an application may be a plug-in to a browser, a piggyback service, etc. The service may be an application and/or a special service for managing connections for other applications by operating as a local TCP proxy. Additionally, the service may be a software program or a software library (*.so, *.a, *.dll), which can be used by an application as a plug-in or as part of application functionality linked in a compile function (static library) or a run time (dynamic library).

The ‘ECHO’ message may be sent to the echo server from the perspective of the various data providers via the user device. For example, if the client device has four ports for WIFI, 4G1, 4G2 and SAT, respectively, then during an active session with the WIFI network via port one, for example, the echo messages are sent from each of the ports of the client device to ensure quality and identify which connections are best/worse, etc. Client monitoring happens on the application level as part of the application or as a linked library, or shared proxy service. The client monitoring manages connections and perform monitoring for a specific application. Failures of the application do not affect other similar applications operating on the same platform and using similar connection management/monitoring functionality.

Network monitoring operates as a special service on the system level. The results of such monitoring affect the applications operating on the same platform. During the monitoring and echo procedures, there may be more than one data connection serving as a backup connection(s) on the application level. Modifications to the operating system make it possible to maintain connections via different providers simultaneously. In other words, the platform may be operating as a router with dynamic port-route persistence rules. The ‘destination’ may be the ‘well known’ server. When the static routes are configured, the target IP address or network is the destination.

The operations of a method or algorithm described in connection with the embodiments disclosed herein may be embodied directly in hardware, in a computer program executed by a processor, or in a combination of the two. A computer program may be embodied on a computer readable medium, such as a storage medium. For example, a computer program may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

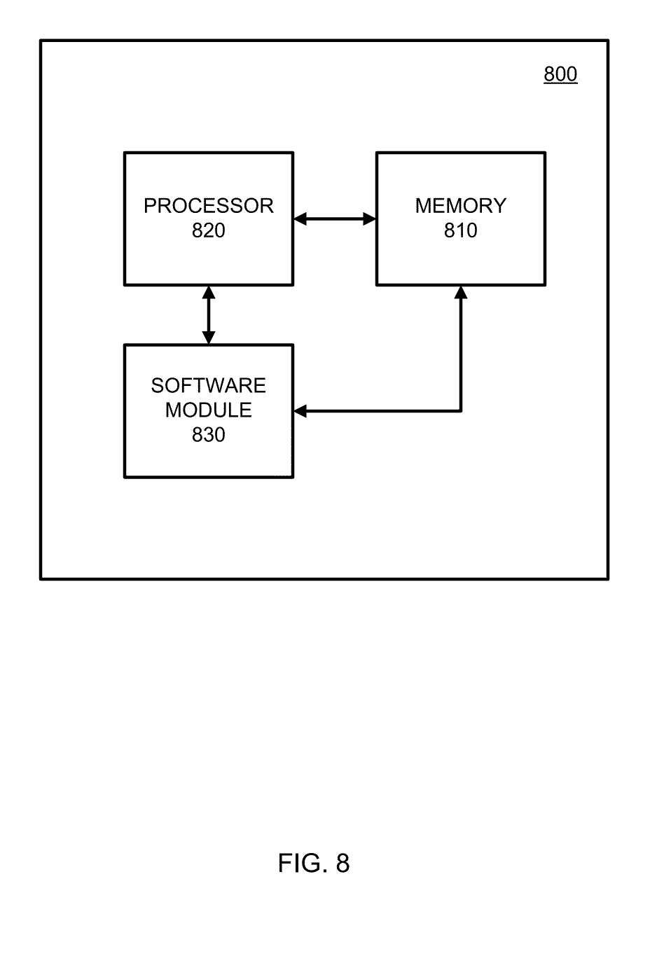

An exemplary storage medium may be coupled to the processor such that the processor may read information from, and write information to, the storage medium. In the alternative, the storage medium may be integral to the processor. The processor and the storage medium may reside in an application specific integrated circuit (“ASIC”). In the alternative, the processor and the storage medium may reside as discrete components. For example FIG. 8 illustrates an example network element 800, which may represent any of the above-described network components, etc.

As illustrated in FIG. 8, a memory 810 and a processor 820 may be discrete components of the network entity 800 that are used to execute an application or set of operations. The application may be coded in software in a computer language understood by the processor 820, and stored in a computer readable medium, such as, the memory 810. The computer readable medium may be a non-transitory computer readable medium that includes tangible hardware components in addition to software stored in memory. Furthermore, a software module 830 may be another discrete entity that is part of the network entity 800, and which contains software instructions that may be executed by the processor 820. In addition to the above noted components of the network entity 800, the network entity 800 may also have a transmitter and receiver pair configured to receive and transmit communication signals (not shown).

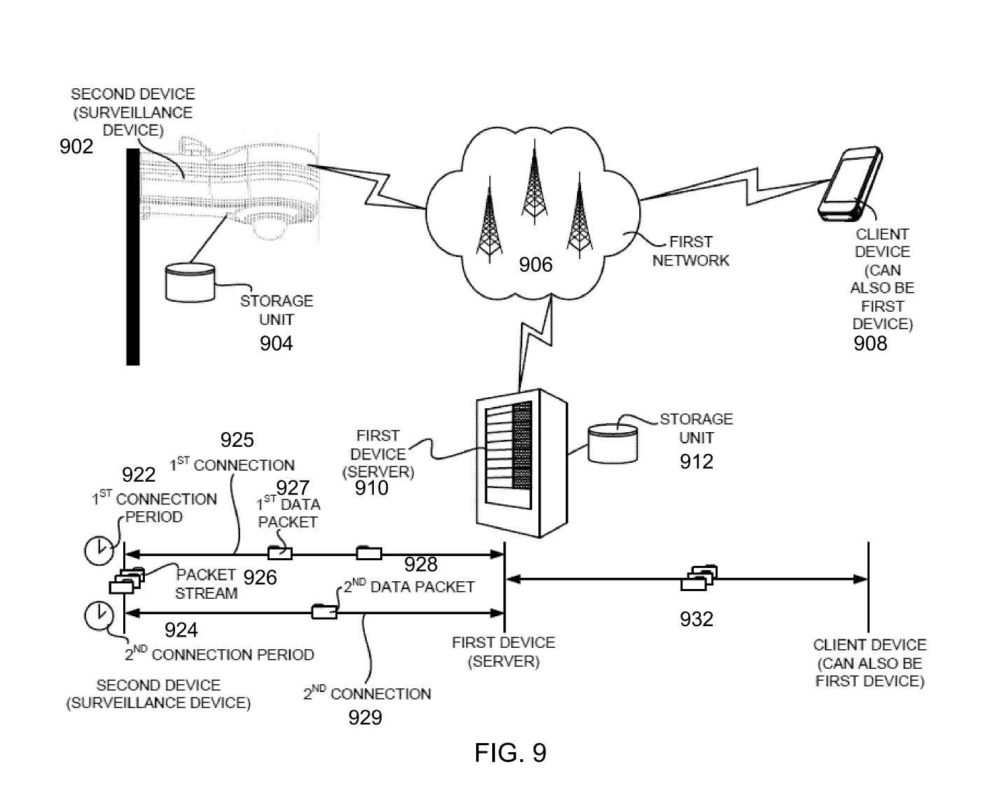

FIG. 9 illustrates a surveillance device operating on a corresponding data network for a first and second connection period according to example embodiments. Referring to FIG. 9, the surveillance device 902 may be an omni-directional camera with various sensors including light detection, audio detection, motion detection and video and audio recording capabilities. The storage unit 904 may be part of the camera or a separate storage unit. The network 906 may include cellular base stations which communicate directly with the device via a TX/RX in the surveillance device. A client device 908 may receive updates from the surveillance device 904 via the network. The server 910 may include its own storage unit 912. As connection periods mature 922 and 924, first and second connections 925 and 929 may provide packet data including a first data packet 927 a packet stream 926 and a second data packet 928 depending on the schedule of the timer and connection periods. The data may be sent from the surveillance device 902 to the server which sends the compiled data 932 to a client device for reference and viewing purposes.

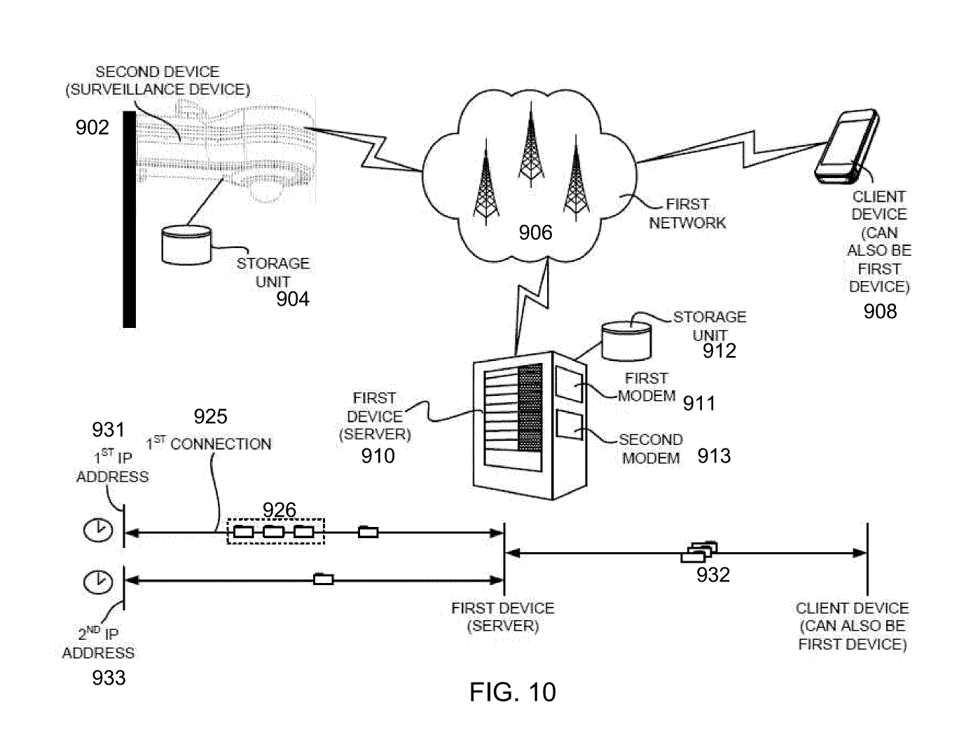

FIG. 10 illustrates a surveillance device operating on a corresponding data network for a first and second IP address according to example embodiments. Referring to FIG. 10, the server 910 may have a first modem or port configuration 911 for processing the first connection data via a first IP address 931. Similarly, server 910 may have a second IP address 933 associated with a second modem 913. In operation, a first set of packets 916 may be sent across the first connection 925 according to a particular schedule.

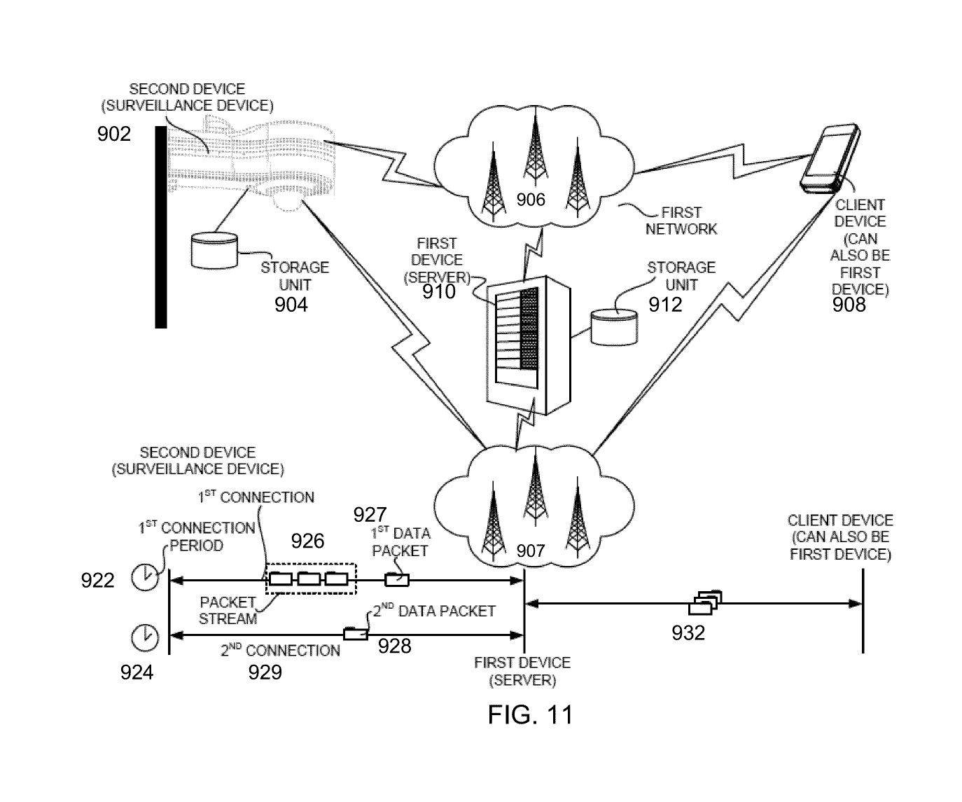

FIG. 11 illustrates a surveillance device operating on a corresponding data network for a first and second connection period with an alternative network configuration according to example embodiments. Referring to FIG. 11, the configuration may include another network 907 as a second cellular network by which the second packet stream is sent when the automated surveillance device capture stream requires a second connection and corresponding network. For example, if the first network is busy or is not working properly, the second network 907 and connection 929 may be necessary to maintain data forwarding events.

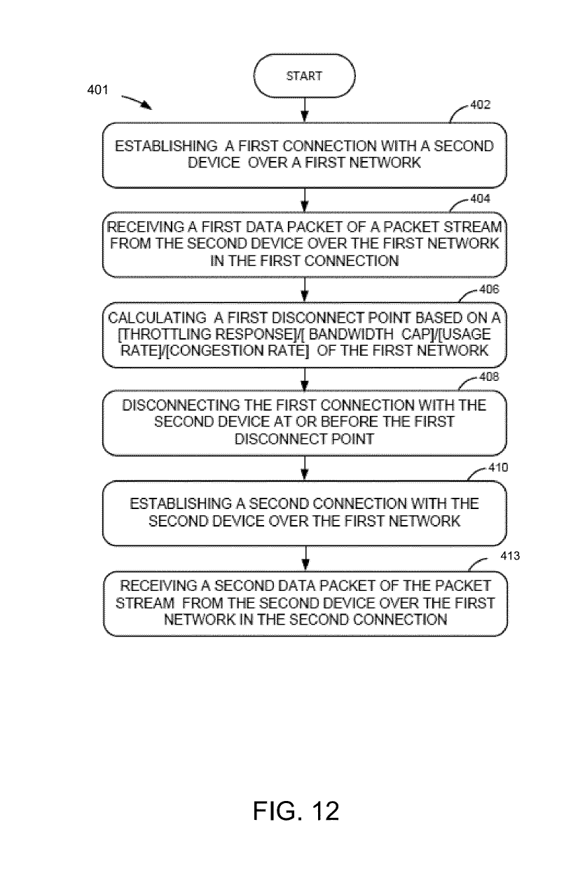

FIG. 12 illustrates a flow diagram of a first and second network configuration and testing packet configuration according to example embodiments. Referring to FIG. 12, the operations 401 include a first connection being established with a second device over a first network 402, a first packet is received from a packet stream from the second device (surveillance device) of the first network and first connection 404. Next, a first disconnect point is calculated based on a throttling response and/or bandwidth capacity and/or usage rate and/or congestion rate of the first network 406. The first connection may then be disconnected from the second device before the first disconnect point 408. A second connection is then established 410 with the second device over the first network and a second data packet of the packet stream is then received from the second device over the first network via the second connection 413.

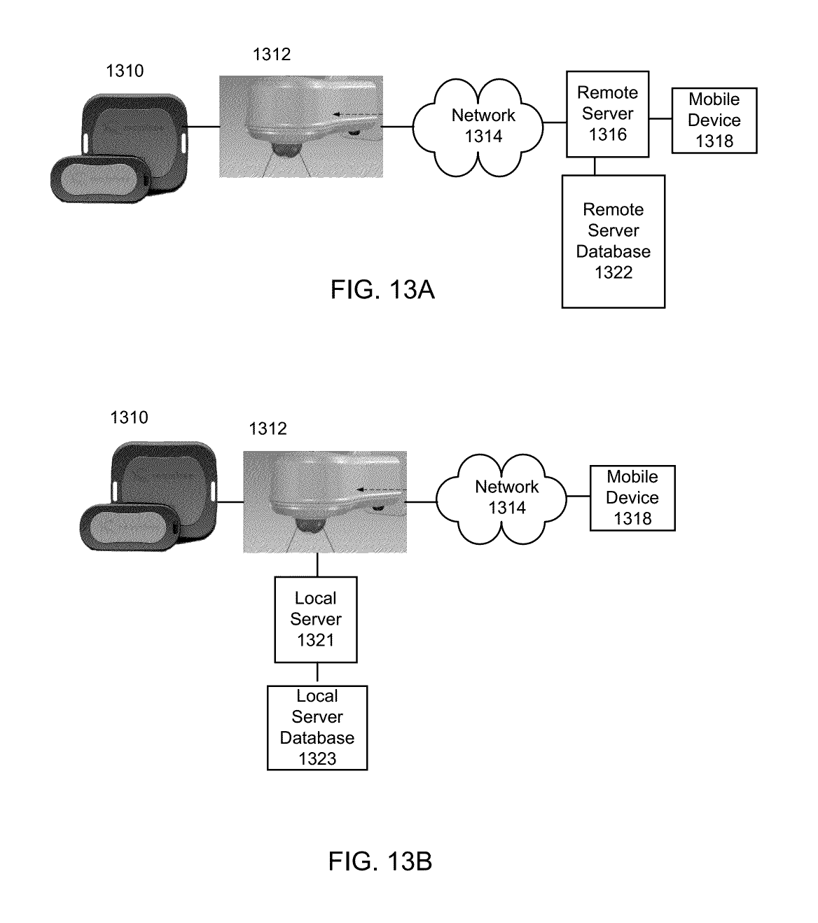

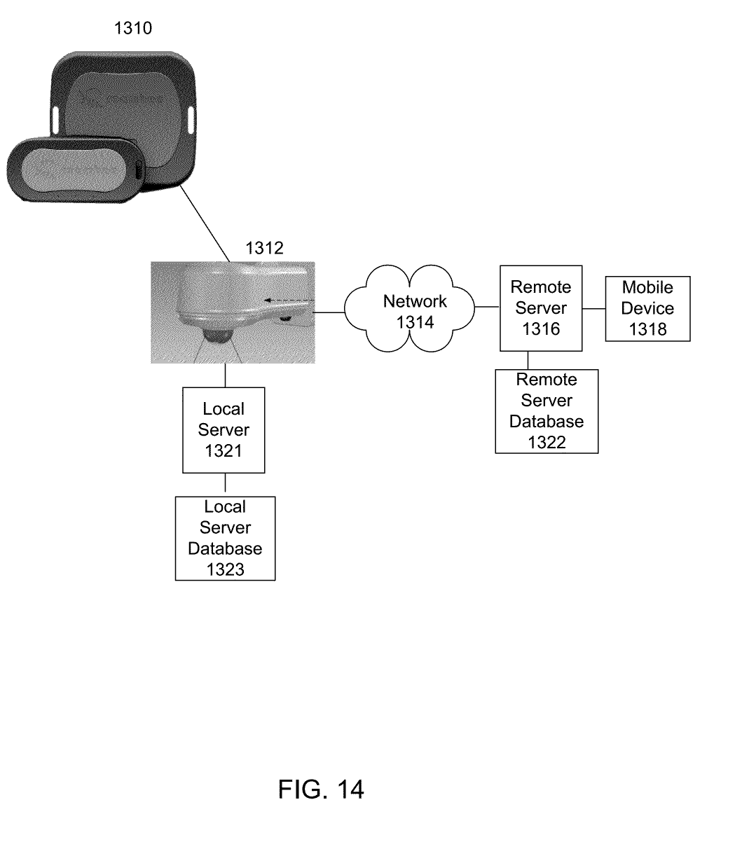

FIG. 13A illustrates a camera and sensor configuration according to example embodiments. Referring to FIG. 13A, the ROAMBEE sensor(s) 1310 may be within a communication range of the surveillance device 1312 via RF, RFID, WIFI, etc., and a network 1314 may be used to forward the detected movements to a remote server 1316 for logging the detection events. A remote database 1322 may store the events in a user profile and share the information with a mobile device 1318 associated with the data detected. FIG. 13B illustrates another camera and sensor configuration according to example embodiments. Referring to FIG. 13B, the device 1312 may have its own local server 1321 and local database 1323. Also, FIG. 14 illustrates yet another camera and sensor configuration according to example embodiments. In FIG. 14, the device may communicate with both local and remote servers.

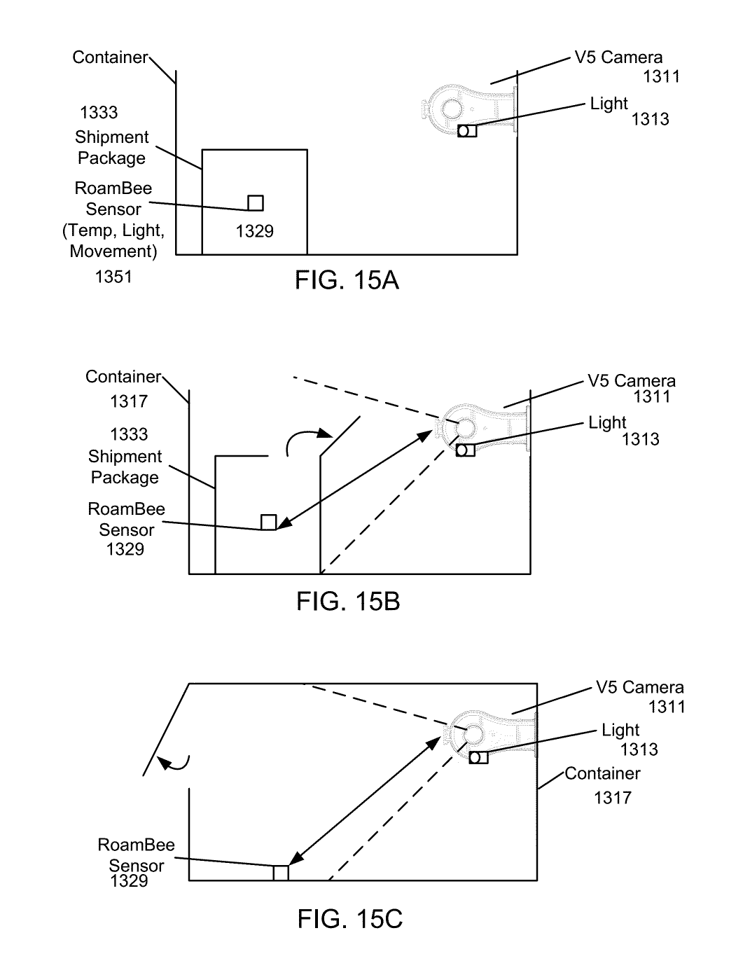

FIG. 15A illustrates a camera and shipment package measurement network configuration according to example embodiments. Referring to 15A, the device may include a camera 1311 and a light used to detect movement and the sensor 1329 via a shipment package 1333. The container 1317 may include the package and the sensor so any attempt to move the contents may be readily detected as the container is opened in FIG. 15C or as the shipment container is opened in FIG. 15B.

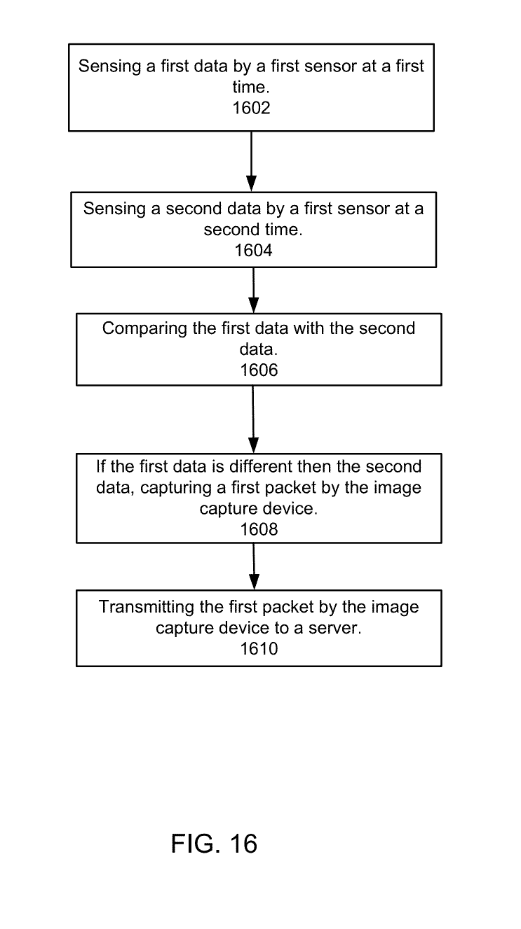

FIG. 16 illustrates a flow diagram of a sensor measurement and packet measuring configuration according to example embodiments. Referring to FIG. 16, the operations may include sensing a first data by a first sensor at a first time 1602. The sensor may also sense a second data at the first sensor at a second time 1604. The data may be compared 1606 to determine if the data is different and if so then a first packet is captured by the image capture device 1608 and the first packet is transmitted by the device to a server 1610.

One example method of operation of the data capturing and sensor configuration may include establishing a first connection with a second device over a first network, receiving a first data packet of a packet stream from the second device over the first network in the first connection, calculating a first disconnect point based on any of a throttling response/bandwidth cap threshold/usage rate/congestion rate, etc., of the first network. Next, the first connection is disconnected with the second device at or before the first disconnect point, and a second connection with the second device over the first network is established, and a second data packet of the packet stream is received from the second device over the first network in the second connection.

Another example embodiment may include managing a network connection provided by a network carrier by establishing one or more test connections with a second device over a first network provided by a first network carrier, identifying one or more terminations of the one or more test connections initiated by the first network carrier due to the first device exceeding a bandwidth cap set by the first network carrier, determining a connection time limit based on the one or more terminations of the one or more test connections, establishing a first connection with the second device over the first network, disconnecting the first connection with the second device at or before the connection time limit, and establishing a second connection with the second device over the first network.

An example embodiment for accessing a data stream may include receiving a request for the data stream from a client device, establishing a connection with a second device to receive the data stream over a network, determining a connection time limit based on a throttling response of the network, disconnecting the connection with the second device at or before the connection time limit, and re-establishing the connection with the second device at or before a disconnection time limit after disconnecting the connection with the second device.

The first network may be a cellular network. The first data packet and the second data packet may include video image frames. The packet stream may be a video stream. Also, the first device may be a server and the second device may be an image capture device. The first device may also be a client device while the second device is a server. In operation, the first data packet may be stitched and compiled with the second data packet into a stitched/compiled data file, and the stitched/compiled data file may be transmitted to a client device requesting the stitched/compiled data file.

The second connection may be disconnected with the second device at or before a second disconnect point, so the second disconnect point is different than the first disconnect point. Next, the first connection is established with the second device through a first modem of the server, and the second connection is established with the second device through a second modem of the server, and the first modem has a different IP address than the second modem.

Additionally, a third connection may be established with the second device over a second network, and a third data packet of the packet stream may be received from the second device over the second network in the third connection. The first connection may have a first connection identifier assigned by the first network, the second connection may have a second connection identifier assigned by the first network, and the first connection identifier is different from the second connection identifier. The first disconnect point is between around 1 millisecond and around 30 milliseconds after a commencement of the first connection. In other embodiments, the first disconnect point can be between around 1 millisecond and greater than 30 milliseconds. The first connection may have a bandwidth cap of X megabits per second (Mbps—where X is between around 0.5 and around 2 Mbps). In another example, the first connection period may be varied based on a traffic-shaping algorithm of the first network. Also, the packet stream may be a high-definition or standard video stream.

According to another example embodiment, a security system may include a first sensor configured to sense a first data at a first time and a second data at a second time, a first media capture device, so the first media capture device is configured to capture a first packet when the first data is different than the second data, and a transmitter configured to transmit the first packet to a server. Additionally, the first sensor may be configured to measure temperature or light intensity. Moreover, the first media capture device is configured to be angled relative to the transmitter and the transmitter is configured to transmit the first packet to a mobile device and the sensor is coupled to the first media capture device. The sensor may be separate from the first media capture device, and the sensor is configured to wirelessly communicate with the first media capture device via BLUETOOTH.

A second media capture device may also be included which may be angled and having a second sensor. The configuration may also include a light emitter, so the light emitter is coupled to the first media capture device, and the light emitter faces in the same direction as the first media capture device. The light emitter is configured to emit light when the first media capture device captures the first packet, and the light is configured to be directed in the direction of the first sensor. The light emitter is configured to emit light when the first data is different than the second data, and the light is configured to be directed in the direction of the first sensor.

According to one example method of operation, a method for surveillance may include sensing a first data by a first sensor, transmitting the first data to an image capture device sensing a second data by the first sensor, transmitting the second data to the image capture device, capturing a first packet by the image capture device when the second data is different than the first data, and transmitting the first packet to a server. The first sensor may sense temperature. The first data is transmitted to an image capture device via a wireless path and the first packet is transmitted to the server wirelessly. The first packet is transmitted from the server to a mobile device. In operation, a light may light a target area when the second data is different than the first data. A first data may be received by a media capture system from a first sensor and a second data may be received by the media capture system from the first sensor. The first data can then be compared to the second data and a first packet may be captured by the media capture system when the second data is different than the first data. As a result, the first packet is transmitted by the media capture system to a server.

Although an exemplary embodiment of the system, method, and computer readable medium of the present application has been illustrated in the accompanied drawings and described in the foregoing detailed description, it will be understood that the application is not limited to the embodiments disclosed, but is capable of numerous rearrangements, modifications, and substitutions without departing from the spirit or scope of the application as set forth and defined by the following claims. For example, the capabilities of the system of FIG. 32 can be performed by one or more of the modules or components described herein or in a distributed architecture and may include a transmitter, receiver or pair of both. For example, all or part of the functionality performed by the individual modules, may be performed by one or more of these modules. Further, the functionality described herein may be performed at various times and in relation to various events, internal or external to the modules or components. Also, the information sent between various modules can be sent between the modules via at least one of: a data network, the Internet, a voice network, an Internet Protocol network, a wireless device, a wired device and/or via plurality of protocols. Also, the messages sent or received by any of the modules may be sent or received directly and/or via one or more of the other modules.

One skilled in the art will appreciate that a “system” could be embodied as a personal computer, a server, a console, a personal digital assistant (PDA), a cell phone, a tablet computing device, a smartphone or any other suitable computing device, or combination of devices. Presenting the above-described functions as being performed by a “system” is not intended to limit the scope of the present application in any way, but is intended to provide one example of many embodiments of the present application. Indeed, methods, systems and apparatuses disclosed herein may be implemented in localized and distributed forms consistent with computing technology.

It should be noted that some of the system features described in this specification have been presented as modules, in order to more particularly emphasize their implementation independence. For example, a module may be implemented as a hardware circuit comprising custom very large scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, comprise one or more physical or logical blocks of computer instructions that may, for instance, be organized as an object, procedure, or function. Nevertheless, the executables of an identified module need not be physically located together, but may comprise disparate instructions stored in different locations which, when joined logically together, comprise the module and achieve the stated purpose for the module. Further, modules may be stored on a computer-readable medium, which may be, for instance, a hard disk drive, flash device, random access memory (RAM), tape, or any other such medium used to store data.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

It will be readily understood that the components of the application, as generally described and illustrated in the figures herein, may be arranged and designed in a wide variety of different configurations. Thus, the detailed description of the embodiments is not intended to limit the scope of the application as claimed, but is merely representative of selected embodiments of the application.

One having ordinary skill in the art will readily understand that the application as discussed above may be practiced with steps in a different order, and/or with hardware elements in configurations that are different than those which are disclosed. Therefore, although the application has been described based upon these preferred embodiments, it would be apparent to those of skill in the art that certain modifications, variations, and alternative constructions would be apparent, while remaining within the spirit and scope of the application. In order to determine the metes and bounds of the application, therefore, reference should be made to the appended claims.

While preferred embodiments of the present application have been described, it is to be understood that the embodiments described are illustrative only and the scope of the application is to be defined solely by the appended claims when considered with a full range of equivalents and modifications (e.g., protocols, hardware devices, software platforms etc.) thereto.

What is claimed is:

1. A method comprising:
establishing a first data session between a client device and a first data service provider;
monitoring the data session for a loss of communication data for a predetermined period of time;
identifying the predetermined period of time has expired without data session activity;
terminating the first data session;
retrieving data session preferences from memory; and
establishing a second data session between the client device and a second data service provider based on the data session preferences.

2. The method of claim 1, wherein the first data session is established via a first port of the client device and the second data session is established via a second port of the client device.

3. The method of claim 1, wherein identifying the predetermined period of time has expired without data session activity comprises no acknowledgment message received at the client device within the predetermined period of time.

4. The method of claim 1, further comprising:
identifying a first data session preference for connection reliability;
identifying a second data session preference for connection cost; and
selecting the second data service provider based on the first data session preference and the second data session preference.

5. The method of claim 4, wherein the first data service provider comprises at least one of a local WIFI connection and a wired connection and the second data service provider comprises at least one of a 4G cellular data provider and a satellite data provider.

6. The method of claim 1, further comprising:
transmitting at least one data packet to the first data service provider;
initiating a timer responsive to transmitting the at least one data packet;
determining no acknowledgment was received within the predetermined period of time; and
transmitting a request to initiate a data session with the second data service provider.

7. The method of claim 1, further comprising:
transmitting a message to an echo server to identify a candidate data service provider;
receiving an echo response message; and
selecting the candidate data service provider as the second data service provider based on the echo response message when the first data service provider fails to provide data services to the client device.

8. An apparatus comprising:
a transmitter configured to establish a first data session between a client device and a first data service provider; and
a processor configured to
monitor the data session for a loss of communication data for a predetermined period of time,
identify the predetermined period of time has expired without data session activity,
terminate the first data session,
retrieve data session preferences from memory, and
establish a second data session between the client device and a second data service provider based on the data session preferences.

9. The apparatus of claim 8, wherein the first data session is established via a first port of the client device and the second data session is established via a second port of the client device.

10. The apparatus of claim 8, wherein the predetermined period of time is identified as expired without data session activity comprises a determination that no acknowledgment message is received at the client device within the predetermined period of time.

11. The apparatus of claim 8, wherein the processor is further configured to
identify a first data session preference for connection reliability,
identify a second data session preference for connection cost, and
select the second data service provider based on the first data session preference and the second data session preference.

12. The apparatus of claim 11, wherein the first data service provider comprises at least one of a local WIFI connection and a wired connection and the second data service provider comprises at least one of a 4G cellular data provider and a satellite data provider.

13. The apparatus of claim 8, wherein the transmitter is further configured to transmit at least one data packet to the first data service provider, and
the processor is further configured to initiate a timer responsive to transmitting the at least one data packet, determine no acknowledgment was received within the predetermined period of time, and the transmitter is also configured to transmit a request to initiate a data session with the second data service provider.

14. The apparatus of claim 8, wherein the transmitter is further configured to transmit a message to an echo server to identify a candidate data service provider, and receive an echo response message, and
the processor is further configured to select the candidate data service provider as the second data service provider based on the echo response message when the first data service provider fails to provide data services to the client device.

15. A non-transitory computer readable storage medium configured to store instructions that when executed cause a processor to perform:
establishing a first data session between a client device and a first data service provider;
monitoring the data session for a loss of communication data for a predetermined period of time;
identifying the predetermined period of time has expired without data session activity;
terminating the first data session;
retrieving data session preferences from memory; and
establishing a second data session between the client device and a second data service provider based on the data session preferences.

16. The non-transitory computer readable storage medium of claim 15, wherein the first data session is established via a first port of the client device and the second data session is established via a second port of the client device.

17. The non-transitory computer readable storage medium of claim 15, wherein identifying the predetermined period of time has expired without data session activity comprises no acknowledgment message received at the client device within the predetermined period of time.

18. The non-transitory computer readable storage medium of claim 15, wherein the processor is further configured to perform:
identifying a first data session preference for connection reliability;
identifying a second data session preference for connection cost; and
selecting the second data service provider based on the first data session preference and the second data session preference.

19. The non-transitory computer readable storage medium of claim 18, wherein the first data service provider comprises at least one of a local WIFI connection and a wired connection and the second data service provider comprises at least one of a 4G cellular data provider and a satellite data provider.

20. The non-transitory computer readable storage medium of claim 15, wherein the processor is further configured to perform:
transmitting at least one data packet to the first data service provider;
initiating a timer responsive to transmitting the at least one data packet;
determining no acknowledgment was received within the predetermined period of time;
transmitting a request to initiate a data session with the second data service provider;
transmitting a message to an echo server to identify a candidate data service provider;
receiving an echo response message; and
selecting the candidate data service provider as the second data service provider based on the echo response message when the first data service provider fails to provide data services to the client device.
